(19) United States
(12) Patent Application Publication
(10) Pub. No.: US 2007/0219938 A1
(43) Pub. Date: Sep. 20, 2007

(54) Attribute-Based Symbology Through Functional Styles

(75) Inventors: Mike Boersma, Harvest, AL (US); Jaroslav Jahoda, Novy Bor (CZ)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Intergraph Software Technologies Co., Las Vegas, NV (US)

(21) Appl. No.: 11/673,295

(22) Filed: Feb. 9, 2007

Related U.S. Application Data
(60) Provisional application No. 60/774,951, filed on Feb. 17, 2006.

(51) Int. Cl. G06F 17/30

(52) U.S. Cl. 707/1; 717/120

(57) ABSTRACT

A method for a computer system includes retrieving values of one or more attributes from a database, performing a computational function upon the values of the one or more attributes to determine a value for a style property associated with a map symbol, and outputting a representation of a map comprising the map symbol having the value for the style property.

### CROSS-REFERENCE TO RELATED APPLICATIONS

The present application claims priority to provisional application No. 60/774951, filed Feb. 17, 2006. This disclosure is hereby incorporated by reference in their entirety for all purposes.

### BACKGROUND OF THE INVENTION

The present invention relates to mapping. More specifically, the present invention relates to the specification of symbols on a map.

It is often said that a picture is worth a thousand words. In some instances, pictures are worth even more. This is especially true with respect to cartographic images, or maps. Typically, maps display the geographic or spatial relationships between elements, such as roads, cities, geologic features, topographic features, and the like. Additionally, maps have been generated that represent data other than mere geographic relationships.

In some instances, maps may include indicators that represent non-geographic properties of an element, such as the importance of the element, and the like. As examples, cities that are government centers are often represented with a star-like symbol on a map; roads that are heavily traveled are often represented by thick, colored-lines; hospitals are often represented with red cross icons; airports are represented by airplane icons, and the like.

In some other instances, maps may include indicators that depend upon social or financial properties associated with a region of the map. For example, population of a city may influence the font-size of the city name on a map, the crime rate in a neighbor may influence the color of the neighborhood on a map, the income of residences within a region may influence the display of symbols on the map, e.g. ¢, $, $$, etc.

To generate maps, two components are often required, data and a mapping system. These pieces are often a product of two different groups/organizations. For example, a data acquisition entity is typically responsible for gathering and/or buying data and providing data in the form of a database. In the case of a mapping system, a mapping entity is typically responsible for accessing data stored in the database, specifying what data will be included in a map and how it will appear. Because these functions are quite disparate, they are often performed by completely different entities. In some cases, these two entities may be separate groups within a company, in some cases separate companies or organizations, and the like. For example, a database company may compile viewership data of television programs or the like, which may be sold to companies that provide output maps.

The value of some maps are often related to how often they are updated. With printed maps, they are often out of date right after they are printed. For example, European maps became obsolete after East and West Germany unified, planetary maps became obsolete when Pluto was demoted to a dwarf planet, and the like. This is often because the data used to generate the map becomes out of date.

In contrast to printed maps, on-line maps/electronic mapping systems generate maps that tend to be more up to date. This is because such mapping systems are often able to retrieve data from electronic databases in real-time, regularly, e.g. at midnight, or the like. As an example, some electronic maps can provide real or near-real-time traffic data, road closures information, weather conditions, and the like.

From the above, the inventors have recognized that a limitation faced by users who create and distribute maps is that they are limited or constrained by the data provided by the database. For example, they are limited to how often the data is updated. More importantly, they are limited to the specific data presented. In other words, they can only map data that is provided in the database.

From experience, the inventors have determined that map developers are sometimes “closer” to the end-user customers of the generated maps than the database providers. For example, customers may specify the type of data they want to see on the map, customers can specify to the map developers the appearance of the map, and the like. Merely as an example, when evaluating a home to purchase, a customer may request to see flood zone data on a map, or earth quake risk data on the map, or land slide risk data on the map, or the like.

A drawback with the current way of mapping is that to provide the desired information on the maps, that the exact requested data must first be available from the database. In cases where the data is not present, the mapping systems users must convince the database user to either obtain such data, or to add attributes that may be computations on existing data. Importantly, database users are often hesitant to expand the number of attributes or tables in the database. This is because database administrators often desire to limit the number of new attributes, to maintain the performance of the database. As a result, it is often difficult, and time-consuming to have databases updated with customer-requested data.

In light of the above, what is desired are ways to increase functionality of electronic mapping systems, reducing the drawbacks described above.

### BRIEF SUMMARY OF THE INVENTION

The present invention relates to mapping. More specifically, the present invention relates to attribute-based expressions for map features. Using various embodiments, attribute-based output, e.g. symbology are provided on a map display.

In various embodiments of the present invention, attribute-based symbology is a technique used in user displays of maps. Using various embodiments, individual map features (e.g. points representing cities, roads, etc.) are rendered (displayed) with style properties (e.g. color, size, symbol name) according to the values of attributes (e.g. population, value) associated with those map features. For example, a city can be rendered with a symbol having a unique size that is determined according to the population of the city (an attribute). More generally, attributes are textual or numeric forms of data displayed as text.

In various embodiments of the present invention, innovative techniques for achieving attribute-based symbology through the use of functional styles are described. The functional styles provided in some embodiments are the synthesis of a flexible style definition system with a flexible expression evaluation system. Given this approach, rendering instructions for map features may be stored via a style definition.

In various embodiments, any number of style definitions may exist in a system—there are, for example, different style definitions available for points, lines, areas, text, raster, and the like. In some embodiments, style definition includes a number of style properties, each representing a graphic characteristic (e.g. color) for that style definition. To achieve attribute-based symbology in some embodiments, style properties have an associated expression that may dynamically be computed for each map feature, based on attribute values for that map feature. Accordingly, the style property values are thus a function of the attribute values.

In various embodiments, the expression mechanism is an extraordinarily rich technique for dynamically computing style property values. In some embodiments, an expression is a text string conforming to a specific syntax. In some embodiments, this syntax may be similar to formulas used in conventional spreadsheet programs, such as Microsoft Excel, or the like. For example, some functions include arguments (e.g. AVERAGE); operators (e.g. “+”); literal operands (e.g. “5000”); and operands which reference attribute values (e.g. an attribute named “Population”).

In various embodiments, other types of input for expressions may include geospatial functions/data. These functions may operate on the geometry of map features, e.g. functions for returning a centroid of a polygon, calculating the length of a line, setting the height of a point, or extracting the text from a map label, or the like.

As will be described in detail below, various embodiments teach a novel expression system that allows dynamic computation of style property values, resulting in the dynamic computation and display of attribute-based symbology via functional styles.

According to one aspect of the invention, a method for a computer system is described. One method includes retrieving values of one or more attributes from a database, performing a computational function upon the values of the one or more attributes to determine a value for a style property associated with a map symbol, and outputting a representation of a map comprising the map symbol having the value for the style property.

According to another aspect of the invention, a computer system is disclosed. One apparatus includes a memory configured to store a plurality of map symbols, wherein each map symbol is associated with a plurality of style properties. A device includes a processor coupled to the memory, wherein the processor is configured to retrieve values of one or more attributes associated with a map symbol, wherein the processor is configured to perform a computational function upon the values of the one or more attributes to determine a value for a style property associated with a map symbol, and wherein the processor is configured to provide an output representation of a map comprising the map symbol, in response to the value for the style property associated with the map symbol.

According to yet another aspect of the invention, a computer program product for a computer system including a processor, resident on a computer-readable tangible media is disclosed. Tangible media may include code that directs a processor to retrieving values of one or more attributes associated with a map symbol, code that directs a processor to perform a computational function upon the values of the one or more attributes to determine a value for a style property associated with the map symbol, and code that directs a processor to output a representation of a map comprising the map symbol, in response to the value for the style property associated with the map symbol. The tangible media may include optical storage media (e.g. DVD, CD-ROM, holographic, etc.); magnetic storage media (e.g. hard disk, storage area network, etc.); semiconductor storage media (e.g. flash memory, RAM, etc.).

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings.

FIG. 1 illustrates one embodiment of the present invention;

FIG. 2 is a block diagram of typical computer system according to various embodiments of the present invention;

FIG. 3 illustrates a flow chart according to various embodiments of the present invention;

FIG. 4 illustrates a flow chart according to various embodiments of the present invention; and

FIGS. 5A-5D illustrates an example according to various embodiments of the present invention.

### DETAILED DESCRIPTION OF THE INVENTION

Overview

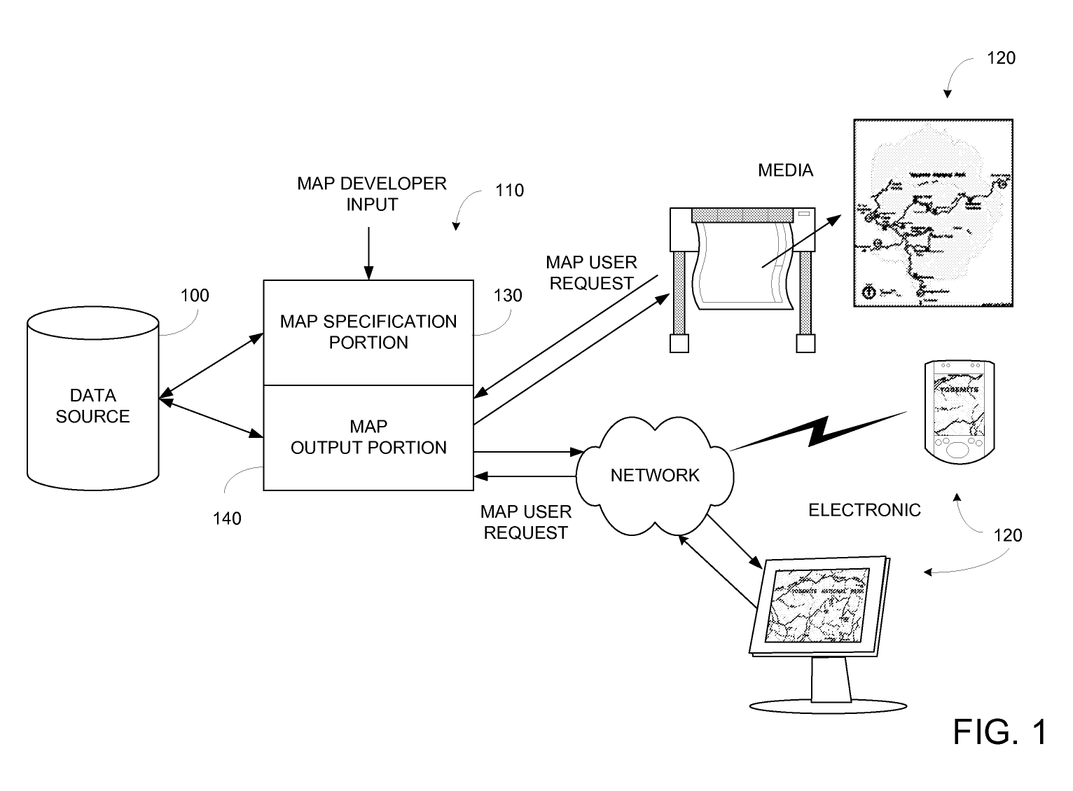

FIG. 1 illustrates one embodiment of the present invention. Some embodiments include a database 100, a mapping system 110, and output maps 120. In various embodiments, mapping system 110 may include a mapping specification portion 130 and a map generation portion 140. In other embodiments, map generation portion 140 may be separate from mapping specification portion 130.

In various embodiments, database 100 typically includes data maintained by a database group (e.g. administrator). Database 100 typically includes a multitude of database tables, attributes, and links between attributes in the tables. In some embodiments, the database group may be a commercial database company that adds new data to the database tables. For example, a database company may compile viewership data of television programs or the like, which may be sold to third parties. In some embodiments, database groups may also implement database computations based on existing database data, to form new database data. For example, based upon the mapping user requirements, custom computations may be performed in the database.

In various embodiments, database 100 and mapping system 110 may be managed by separate users (e.g. independent companies), whereas in other embodiments, database 100 and mapping system 110 may be managed by common users (e.g., by different divisions of a single company, by a single user or research group, or the like).

In various embodiments, mapping system 110 may be implemented by any number of commercially-available geographic visualization/mapping package systems. One such embodiment has been implemented in GeoMedia® geographic information system (GIS) available from Intergraph Corporation. As will be described below, a map developer uses mapping specification portion 130 to specify what elements of a map are to be displayed, what data will be retrieved from database 100, how certain symbols on the map will appear, and the like. The map specification may be stored within a memory of mapping system 110.

In some embodiments of the present invention, map generation portion 140 generates map 120 for display to a user. As an example, map generation portion 140 receives a map request from a customer; retrieves the map specification; retrieves the appropriate data from the database, etc.; dynamically computes values for new attributes; and determines the appearance of symbols for map 120 based upon the computed values. In various embodiments, map 120 may be printed onto media such as paper, plastic, cloth, glass, or the like; and/or map 120 may be displayed on a computing device display. More specifically, map 120 may be displayed via an application program, a web browser, an electronic message, or the like, on a PDA, lap top computer, cell-phone, or the like.

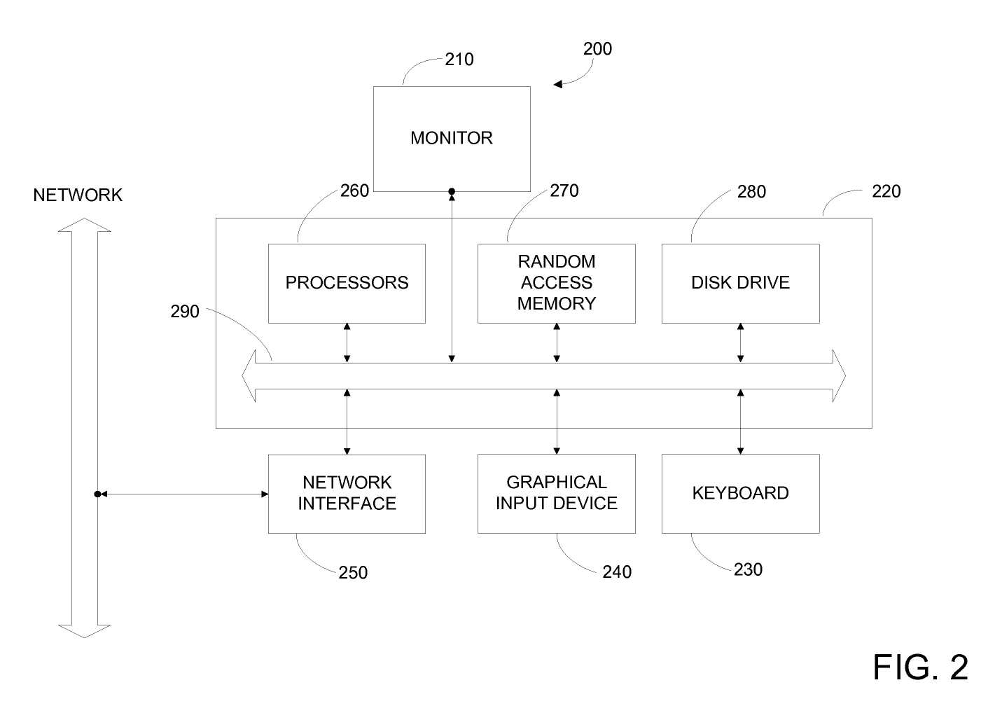

FIG. 2 is a block diagram of typical computer system 200 according to an embodiment of the present invention.

In the present embodiment, computer system 200 typically includes a monitor 210 (with graphics card), computer 220, a keyboard 230, a user input device 240, computer interfaces 250, and the like.

In the present embodiment, user input device 240 is typically embodied as a computer mouse, a trackball, a track pad, a joystick, wireless remote, drawing tablet, voice command system, eye tracking system, and the like. User input device 240 typically allows a user to select objects, icons, text and the like that appear on the monitor 210 via a command such as a click of a button or the like.

Embodiments of computer interfaces 250 typically include an Ethernet card, a modem (telephone, satellite, cable, ISDN), (asynchronous) digital subscriber line (DSL) unit, FireWire interface, USB interface, and the like. For example, computer interfaces 250 may be coupled to a computer network, to a FireWire bus, or the like. In other embodiments, computer interfaces 250 may be physically integrated on the motherboard of computer 220, may be a software program, such as soft DSL, or the like.

In various embodiments, computer 220 typically includes familiar computer components such as a processor 260, and memory storage devices, such as a random access memory (RAM) 270, disk drives 280, and system bus 290 interconnecting the above components.

RAM 270 and disk drive 280 are examples of tangible media configured to store data such as digital source map data, map symbols, a map specification process, a map generation process, embodiments of the present invention, including executable computer code, human readable code, or the like. Other types of computer-readable tangible media include magnetic storage media such as floppy disks, networked hard disks, or removable hard disks; optical storage media such as CD-ROMS, DVDs and bar codes; semiconductor memories such as flash memories, read-only-memories (ROMS); battery-backed volatile memories; networked storage devices, and the like.

In the present embodiment, computer system 200 may also include software that enables communications over a network such as the HTTP, TCP/IP, RTP/RTSP protocols, and the like. In alternative embodiments of the present invention, other communications software and transfer protocols may also be used, for example IPX, UDP or the like.

FIG. 2 is representative of a computer system capable of embodying various aspects of the present invention. It will be readily apparent to one of ordinary skill in the art that many other hardware and software configurations are suitable for use with the present invention. For example, the computer may be a desktop, portable, rack-mounted or tablet configuration. Additionally, the computer may be a series of networked computers.

The use of any micro processors are contemplated, such as Xeon™, Pentium™ or Core™ microprocessors; Turion™ 64, Opteron™ or Athlon™ microprocessors from Advanced Micro Devices, Inc; and the like. Further, various types of operating systems are contemplated, such as WindowsVista®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board.

Methodology

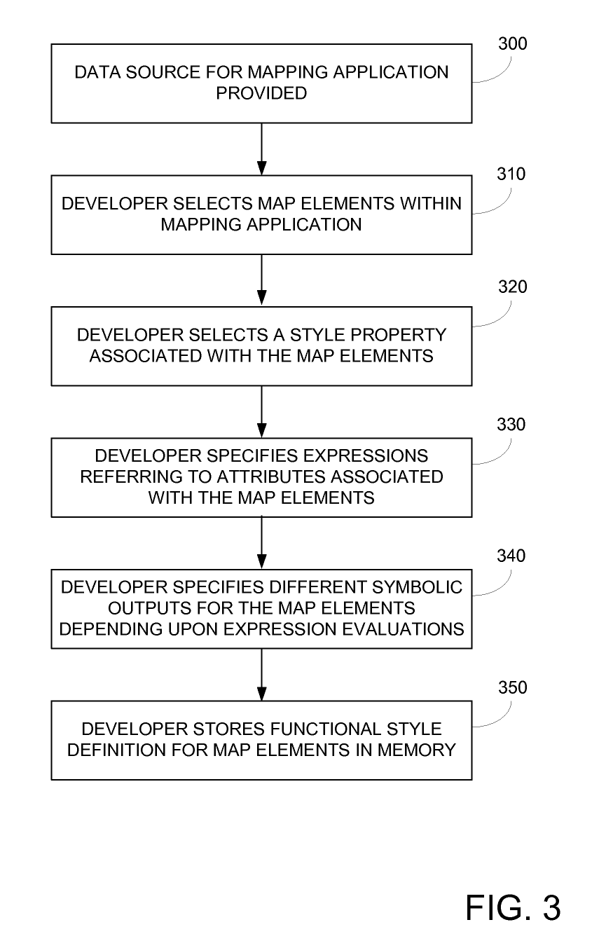

FIG. 3 illustrates a flow chart according to various embodiments of the present invention. More specifically, FIG. 3 illustrates a process for forming a map specification.

In various embodiments, a data source, e.g. a database is provided including a set of data, step 300. The data source may be any commercially database available from Oracle, SAP, or the like. In other embodiments, any other type of data source, e.g. flat file, or the like may be used as a data source. This process may be part of a process manually performed when a map developer creates a new map project and specifies a database, or automatically performed when an existing map project is opened and a link to a database is already specified.

Initially, a map developer may select one or more element or classes of elements on a map, step 310. These elements or classes of elements are ones which the map developer wishes to assign functional styles to, as described below. Any type of map element may be selected, for example, geographic elements, e.g. rivers, mountains, forests, etc.; transportation elements, e.g. roads, highways, ports, etc.; social boundaries, e.g. cities, counties, countries, etc.; or the like.

In various embodiments of the present invention, each of the selected map elements may be characterized by attributes and attribute values. For example, an airport may have attribute values that specify the number of passengers, the number of gates, the security risk, the operating equipment, or the like. In various embodiments, selection of the map elements results in a graphic display of some of these attributes of the map elements to the map developer.

Typically the map elements have a number of stylistic properties such as symbolic output, e.g. color, symbol, thickness, or the like. The map elements may also have default property values associated therewith. In some embodiments of the present invention, the map developer may select a style property of the map elements to modify, or to add a new style property to the map elements, step 320.

In the following steps, a map developer then defines an expression to evaluate in order to determine the value for a style property for the map elements. The appearance, or the like, of the symbol displayed on a map will change, in some embodiments, depending upon the evaluation of that expression.

In various embodiments of the present invention, the map developer provides an expression that may include references to attributes of the map elements, step 330. For example, the expression may specify one or more computations that refer to other attributes. In various embodiments, this expression may be dynamically evaluated at run-time (i.e. when a map is to be generated). In various embodiments, as will be described below, computations may be mathematical operations, logical operations, arithmetic functions, or the like. Additionally, in some embodiments, the computations may include constants, possibly results of other functional styles, or the like.

In various embodiments, the map developer specifies different symbolic outputs for map elements based upon the results of the computation, step 340. In some embodiments of the present invention, conventional programming techniques may be used to specify the different symbolic outputs, for example, using IF-type statements, nested If-type statements, or the like. Other possible embodiments may use CASE-type statements, DO-UNTIL-type statements, loop-type statements, or the like.

In various embodiments, the output may be a visual indicator. Examples of visual indicators may include: different text words, text colors, text size, text appearance; line size, line type, line color; symbol selection, symbol size, symbol color, symbol appearance, or the like. In other embodiments, the sensory output may provided when a user “rolls-over” a map symbol on a display with a cursor, or the like. In some cases, the sensory output may be an auditor indicator. For example, sensory output may include different sound clips, different sound volumes, or the like, when the user rolls-over a map symbol. In some embodiments, the sensory output may be a force-feedback. For example, a mouse movement may have different vibration patterns, vibration intensities, or the like, when the user rolls-over the icons. In still other embodiments, output signals may be specified for a peripheral or auxiliary device (e.g. output to a printer attached to a computer, execution of a program on a PDA, sending of a SMS, sending an IM, logging in a data log, etc.). In light of the above, it should be understood that any way to indicate to a map user, or to any other party, a difference between the representation of the map elements, are included in embodiments of the present invention.

After verifying that the functional style provides the desired differences in symbolic representation of the map elements, the map developer may save the specification of the map, including the specification of the functional style, step 350. In various embodiments, expressions and functional styles may be independently stored from the map specification. In such embodiments it is contemplated that such functional styles may be shared with other map developers. In various examples, functional styles may be e-mailed to other map developers; template files storing the functional styles may be shared, and the like.

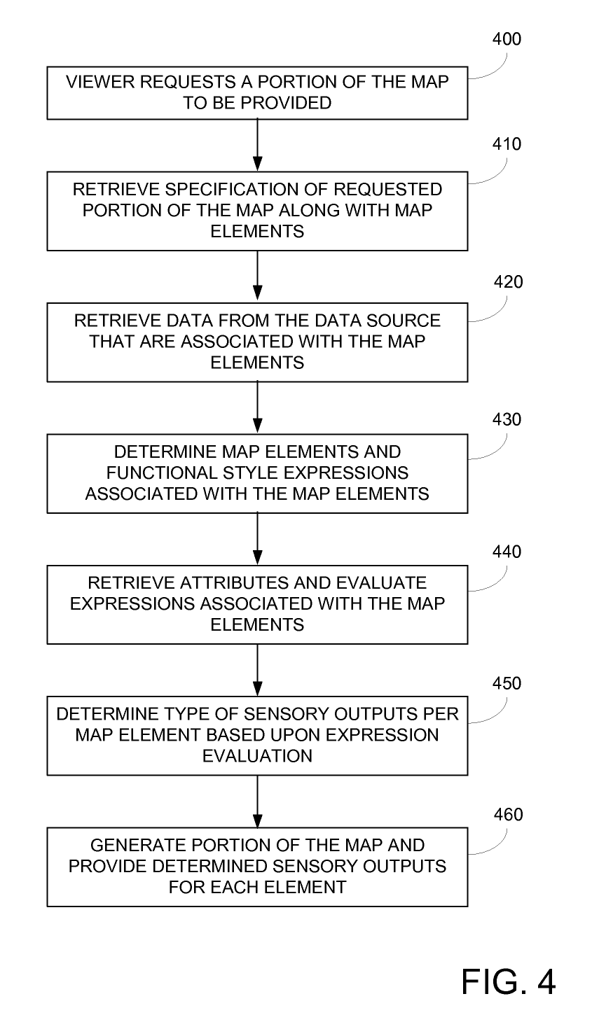

FIG. 4 illustrates a flow chart according to various embodiments of the present invention. More specifically, FIG. 4 describes the process for dynamically generating/or displaying a map.

Initially, a user may request a portion of a map to be output, step 400. In various embodiments, this request may be made by the user directly running map generation portion 140 on a computer system, may be made via one or more web services, or the like. As examples, the user may request display of a map via a web browser on a laptop computer, a PDA, a cell phone, or the like. In various embodiments, the maps may be geographically limited (e.g. for real-estate listings), or specified by an end-user (e.g. Yahoo! maps, Google maps).

In various embodiments, a default portion of the map maybe initially be specified. However, the user may also specifically provide geometric coordinates, field of view, altitude, or the like for generation of the map. The process described herein may also be repeated in the case of an on-line map, when the user pans, zooms, or scrolls, the map.

In other embodiments, the user may also have the ability to select which elements to display on the map. More specifically, in some examples, the user may turn-on or turn-off the display of various map elements depending upon their specific requirements. For example, a user toggles on and off a view of vehicle road traffic conditions on a map, or the like. This user request capability may be defined and/or limited by the map developer in some embodiments.

In response to the request, the data associated with the map may be retrieved within map generation portion 140, step 410. In various embodiments, map generation portion 140 retrieves the specification of the map described in step 350, above, including the specification of functional styles.

In various embodiments, map generation portion 140 retrieves the data specified by the specification of the map from a data source, step 420. In various embodiments, the specification of the map may already include a snapshot of data from the database, thus, no additional database access may be initially required. Based upon this data, and the portion of the map, map generation portion 140 determines which map elements are within the field of view of the map and are requested, step 430.

In some embodiments, in response to the identification of these map elements, the attributes associated with these map elements are determined, step 430. In the case of functional styles, the attributes specified in the expression of the functional styles are retrieved, and the expressions are evaluated, step 440. As can be seen, the evaluation of the expression is determined at run-time, often dynamically based upon “live” database data.

Next, based upon the evaluation of the expressions, the sensory output associated with the map element is determined, step 450, and output, step 460. The type of sensory output typically depends upon the evaluation of the expression based upon “live” data. As mentioned above, the sensory output may be visual, i.e. a different color, a different shape, a different size for a symbol on the portion of the map, a different animated appearance; or the like. Examples of animated appearance may include a symbol or icon changing color in time (e.g. changing from white to blue to white, and repeating); changing intensity in time (e.g. blinking between black and white); changing size in time (ex. icon growing from a small size to a larger size, and repeating); changing appearance in time (e.g. growing, shrinking), changing shape in time (e.g. changing from a circle to a star, and repeating; and the like. Accordingly, in various embodiments, the map developer may specify the animation of the symbol, as discussed above, as well as the timing between changes, i.e. amount of cycle time.

In various embodiments, the sensory output may be auditory, e.g. when a user moves a cursor over a map symbol, different sounds are output, or the like; may be olfactory, e.g. when a user moves a cursor over a map symbol different output scents are output; may be tactile, e.g. when a user moves a cursor over a map symbol, different types of force feedback are output; may be invisible to the user, e.g. a log may be kept of what map symbols are studied by a user; or the like.

Detailed Embodiment

In various embodiments of the present invention, functional style expressions can be implemented using conventional techniques, such as used in spreadsheet programs. Typically, they include operands (data values) and operators that are evaluated to result in an output for the functional style. In some embodiments, expressions may include one or more operands and one or more operators.

In various embodiments, the map operator may create and/or edit expressions via a number of dialog boxes. For example, a map operator may specify an expression by typing values and using operator buttons to insert within an expression dialog box on the Expression dialog box. In various embodiments, a dialog box may also provide a syntax guide for selected functions along with syntax checking. In various embodiments, the dialog box may also provide categories, functions belonging to a selected function category, and attributes that can be used as input parameters for functions.

In various embodiments, the type of data used to represent values in expressions may include Boolean values, byte data, integer, long integer, currency values, single precision data, double precision data, date data, text, long binary data, memo data, graphical data, spatial data, and the like. In other embodiments, other data types are also contemplated.

As discussed above, expressions may be embodied as a combination of operands and operators and are evaluated to get a resulting value. The data can be used in several different places, for example as part of the data to retrieve (in a query) or as a search condition to look for data meeting a set of criteria.

In various embodiments, operands in an expression can include identifiers: references to attributes, in which values vary for each database record; constants: fixed values which are constant for each record; and functions: operations which take inputs and return values. As an example, an expression can be a calculation, such as (price * 1.5) or (price +sales_tax).

In various embodiments, functional styles may result from the evaluation of a variety of functions. For example, functions may include scalar functions that operate on a single value and then return a single value. In various embodiment, scalar functions can be used wherever an expression is valid. An example scalar function may be, determining the X or Y coordinates of a point geometry feature class. In various embodiments, functions may include aggregation functions that operate on a collection of values but return a single e.g., a summarizing value. An example aggregate function may be CREATEPOLYGON to merge a given list of points to define a polygon. In various embodiments, functions may include expansion functions that operate on a single value (e.g. a geometry value) and then return multiple values. An example of an expansion function may be to calculate SEGMENTS of lines.

In various embodiments, the functions are organized into categories such as: date and time functions, geometry functions, logical functions, mathematic and trigonometric functions, statistical functions, text functions, view functions, and the like. In other embodiments, the addition of other types of categories and the addition of other functions are contemplated.

In various embodiments, identifiers are defined as symbols that represent the name of an attribute or a constant. Each attribute name can typically be distinguished from another by using its name and group name. In the following example, identifiers include Detail.Salary and Input.Salary: “IF(COUNT(Detail.Salary)<>0, SUM(Detail.Salary), Input.Salary)” In some embodiments, these identifiers may represent logical data constructs (e.g. attribute names of tables) in a database or data store.

Within expressions, operators are symbols specifying an action performed on one or more operands. In various embodiments, the operator categories include: arithmetic operators (e.g. add, subtract, multiply, divide, modulo, or the like), bitwise operators (e.g. and, or, xor, nor, or the like), comparison operators (e.g. =, >, <, <=, or the like), logical operators (e.g. and, between, null, in, or the like), string concatenation operators, unary operators (e.g. positive, negative, or the like). In other embodiments, the addition of other types of operators are contemplated.

In some embodiments of the present invention, an expression can be built from several smaller expressions, combined by operators. In these complex expressions (with “nested” expressions), the operators are evaluated based on operator precedence. A pseudo code example includes:

current_tax=prior_tax+purchase_value * net_inflation(purchase_year) * tax_rate

### EXAMPLES

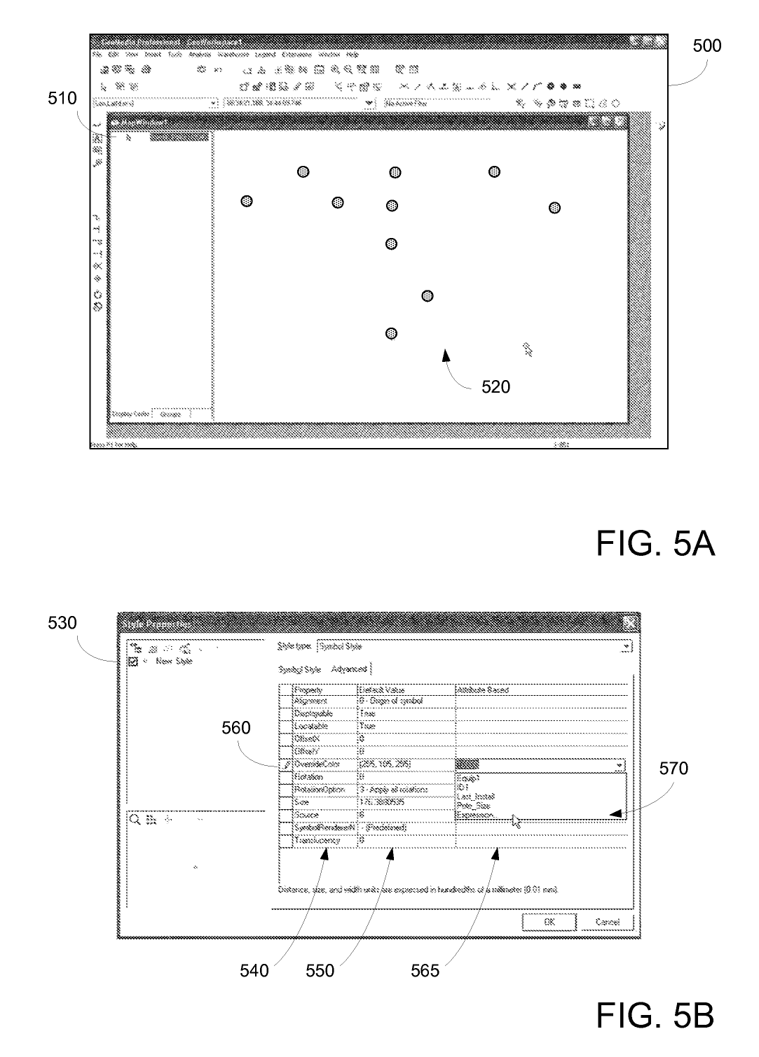

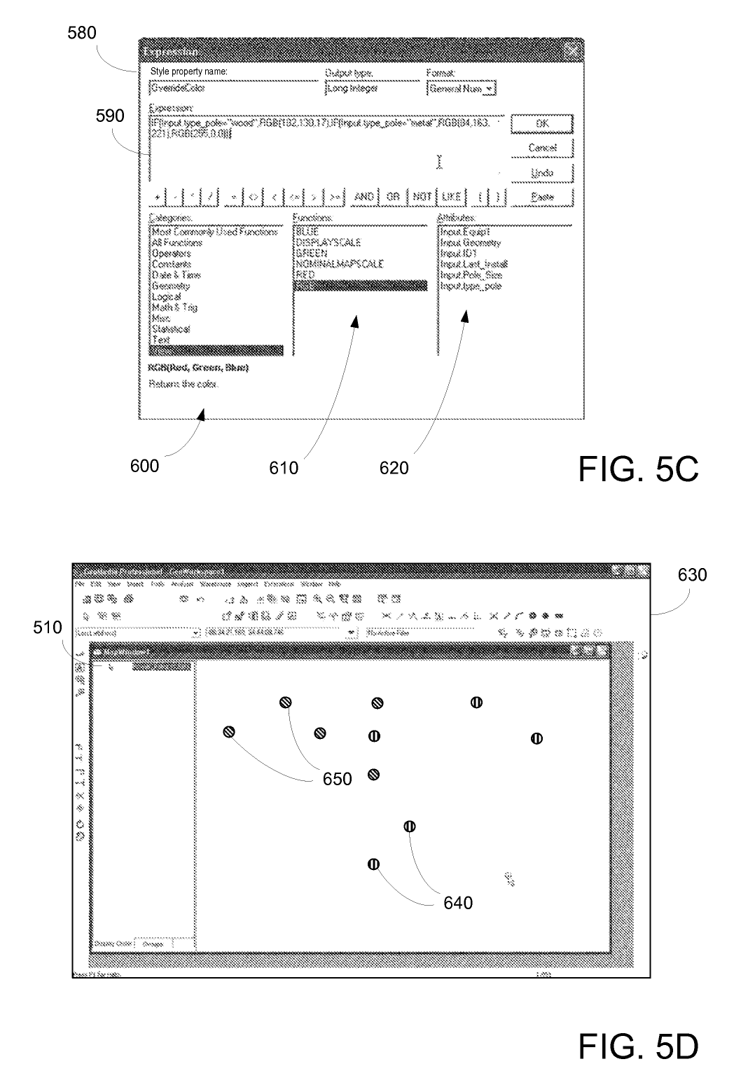

FIGS. 5A-5D illustrates examples according to various embodiments of the present invention. More specifically, FIGS. 5A-D illustrate graphical user interfaces (GUls) according to various embodiments of the present invention.

FIG. 5A illustrates a typical GUI 500 for a map developer. In this embodiment, a map developer selects a portion of the map to display, and specifies map elements 510 to be displayed. In this example, map elements 510 are power poles. As can be seen, in response, symbols 520 are displayed in GUI 500 representing the locations of the power poles in the portion of the map. In the present example, the map developer may change the symbolic representation of the power poles, by changing the style of the symbol, as illustrated below. In various embodiments, the map developer may “right-click” upon map elements 510 to change the style, or in any conventional method.

FIG. 5B illustrates a typical style property dialog box, GUI 530. In FIG. 5B, the current output style for the map element is illustrated in GUI 530. In this example, a map-centric property column 540, and a default values column 550 are shown. In various embodiments, property column 540 specifies the graphical (symbolic) properties of the map symbol, and values column 550 specifies the current values for the symbols. In the example illustrated in FIG. 5B, row 560 specifies an output color for the symbol. In the present instance (255, 105, 255) represents a red, green and blue (RGB) value for the symbol.

As further illustrated in FIG. 5B, an additional attribute column 565 is provided. In the present example, a map developer may click upon attribute column 565 to assign a custom value for the output color for the symbol. In this example, a drop-down box is illustrated including a number of “attributes” associated with the map elements, as will be further seen in FIG. 5C. One attribute, an expression attribute 570, allows the map developer to define an expression to evaluate, as described above.

FIG. 5C illustrates a typical expression dialog box, GUI 580. In FIG. 5C, GUI 580 facilitates and allows the map developer to define an expression within expression region 590. In this example, a category list 600 allows the map developer to specify categories of functions to include into a expression, and a function list 610 allows the map developer to specify the specific function to include into the expression. Additionally, an attribute list 630 is provided, which lists the attributes associated with the map symbol. As shown, in the case of a power pole, the attributes may include the installation equipment requires, the geometry of the pole, the identification number of the pole, the date the pole was installed, the pole size, the type of pole (e.g. metal, wood, concrete). In various embodiments, these attributes for each pole are stored (and later retrieved) from the database.

In the example in FIG. 5C, the map developer has specified an expression to be evaluated to determine an RGB value. As was seen in FIG. 5B, the result of the evaluation (RGB value) is used to determine the color of the power pole symbol on the GUI. The expression in FIG. 5C:

IF (Input.type_pole=“wood”, RGB(182, 130, 17), IF (Input.type_pole=“metal”, RGB(84, 163, 221), RGB(255, 0, 0)))

In this example, the expression means that, if the power pole is wood (Input.type_pole=“wood”), the evaluation of the expression returns an RGB value of (182, 130, 17), that is brown in color. Further, if the power pole is not wood but metal (Input.type_pole=“metal”), the evaluation of the expression returns an RGB value of (84, 163, 221), that is bluish in color. Additionally, if the power pole is not wood or metal, the evaluation of the expression returns an RGB value of (255, 0, 0), that is red in color. As shown in this example, nested-type IF statements, or the like may be used to provide two or more different symbolic outputs for the map elements.

In other examples, other attributes may be used within the evaluation function, such as installation equipment, installation date, or the like.

FIG. 5D illustrates a typical GUI 630 for a map developer. In this embodiment, map elements 510 are displayed in the portion of the map with the output symbology determined by the expression definition shown in FIGS. 5B and 5C. As can be seen, some power poles 640 may be brown, reflecting a “wood” pole attribute, and some power poles 650 may be blue, reflecting a “metal” pole attribute, according to the expression in expression region 590.

In light of the above disclosure, it should be understood that each property of a style may have a different expression associated therewith. For example, to represent cities on a map, a size property for the cities may have an expression that depends upon a population attribute for the cities. Additionally, a color property for the cities may have an expression that depends upon a crime rate of the cities. As still another example, an animation property for the cities may have an expression that depends upon a functional style that computes the change in crime rate over time of the cities. As a result, a city with a large population and a high crime rate may appear as a large red dot on the map; and a city with a large population and a low crime rate may appear as a large green dot on the map. Further, if the change in crime rate over the past ten years for a city has been decreasing, the large red dot may slowly blink; whereas if the change in crime rate over the past ten years for a city has been increasing, the large green dot may quickly blink. The modification and evaluation of expressions for multiple types of style properties associated with map elements are envisioned in various embodiments of the present invention.

Advantages to the map developer/user specifying functional styles within mapping system 110, and not database 100 include that the map developer can define their own functional styles on-the-fly. In other words, as a map developer receives map requirements from an end user, for example, the map developer can quickly and easily implement such requirements. Further, the map developer does not have to wait for a database administrator of database 100 to implement such functions in a database and to update the database data.

In various examples, if the map developer is a “small” developer, the database administrator may decide not to add such functions, because of the administrative overhead. In other words, the database administrator may not believe the advantages of adding such custom attributes outweigh the added database burden. In other examples, the data source provider may not have the capability to calculate the requested attributes because the provider does store any or all of the required underlying data; the data may be generated on-the-fly, thus the data source does not have the persistent storage or capability to add fixed attributes; the data may be from a public or commercial source that does not allow customers to customize the provided data; or the like. In light of the above, it is contemplated that the new attribute, or the like is not retrieved from the database, but is computed dynamically at run-time.

By providing functional styles at the map specification level, map developers can now easily distinguish map elements based upon custom criteria, without having to rely upon the database administrator. As an example, a database may be provided from a County Assessor's office providing sales price of properties, size of a dwelling, and the like. However, the map developer may be interested in color coding regions on a map based upon price per square foot, data that is not provided by the Assessor's office. Accordingly, using various embodiments of the present invention, the map developer may specify an expression using the sales prices of properties, respectively divide them by the square footage of the dwelling, and specify red for regions of high price per square foot red, blue for regions of low price per square foot, and yellow for regions of medium price per square foot.

As an example, a database may be provided by local High School Districts providing number of entering students, number of graduating seniors, college-bound Seniors, and the like. However, the map developer may be interested in different shading for regions on a map based upon High School Districts and based upon college-bound rates, not provided by the High Schools. Accordingly, using various embodiments of the present invention, the map developer may specify an expression using the number of college-bound Seniors, respectively divide them by the number of students in the entering class, and specifying different shading patterns based upon the evaluated rates. For example, one pattern for rates 50% or above, another pattern for 40% or above, another pattern for 30% or above, etc.

In various embodiments, the evaluation of the expressions may more directly influence the value for the attribute. As an example, the population attribute for a city may be used to determine the size of the city symbol on a map, using a pseudo code expression as follows:

Size=(Population/Max_city_population) * Max_city_symbol_size.

In this example, Population would typically be an attribute obtained from the data source, unique for each city; Max_city_population would be the population of the most populous city in the world, country, region of interest, or the like. This data may also be obtained from the data source, be a constant that is manually determined, or the like. Lastly, Max_city_symbol_size would be a size parameter of the maximum desired size of the city symbol on the map. In light of the above, it is expected that no two city symbols of the map will be exactly the same size, because populations of cities are virtually unique.

The above embodiments of this “continuous” symbolic output determination may also be applied to other aspects than symbol size, such as symbol color, symbol, symbol animation, or the like. As examples, city symbol colors on a map may depend upon cities median house price compared to a national median house price; three-dimensional bars representing cities on a map may have a height determined by the growth in jobs in the cities over a certain time period; blinking animation for city symbols on a map may depend upon amount of pollution of the cities, and the like. In light of the above disclosure, it is expected that one of ordinary skill in the art would be able to envision additional examples that are considered embodiments of the present invention.

Further embodiments can be envisioned to one of ordinary skill in the art after reading this disclosure. In other embodiments, combinations or sub-combinations of the above disclosed invention can be advantageously made. The block diagrams of the architecture and graphical user interfaces are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made without departing from the broader spirit and scope of the invention as set forth in the claims.

What is claimed is:

1. A method for a computer system comprises:
retrieving values of one or more attributes from a database;
performing a computational function upon the values of the one or more attributes to determine a value for a style property associated with a map symbol; and
outputting a representation of a map comprising the map symbol, in response to the value for the style property associated with the map symbol.

2. The method of claim 1 further comprising:
displaying the representation of the map to a user.

3. The method of claim 1 further comprising:
identifying one or more geographic locations; and
wherein retrieving values of one or more attributes comprises retrieving values of one or more attributes from the database in response to the one or more geographic locations.

4. The method of claim 1 wherein the style property associated with the map symbol is selected from the group consisting of: font size, font, font color, line weight, line color, type of line, icon size, icon color, icon, animation property.

5. The method of claim 1 wherein the computational function is selected from the group consisting of: logical function, mathematical function, arithmetic function.

6. The method of claim 1 wherein performing the computational function comprises:
determining a value of a function upon the values of the one or more attributes; and
determining the value for the style property in response to the value of the function.

7. The method of claim 1 further comprising:
receiving updated values of the one or more attributes from the database;
performing the computational function upon the updated values of the one or more attributes to determine an updated value for the style property associated with the map symbol; and
outputting an updated representation of the map comprising the map symbol, in response to the updated value for the style property associated with the map symbol.

8. A computer system comprises:
a memory configured to store a plurality of map symbols, wherein each map symbol is associated with a plurality of style properties; and
a processor coupled to the memory, wherein the processor is configured to retrieve values of one or more attributes associated with a map symbol, wherein the processor is configured to perform a computational function upon the values of the one or more attributes to determine a value for a style property associated with a map symbol, and wherein the processor is configured to provide an output representation of a map comprising the map symbol, in response to the value for the style property associated with the map symbol.

9. The computer system of claim 8
wherein the memory is configured to store the computational function specifying the one or more attributes.

10. The computer system of claim 8
wherein the processor is configured to receive indication of a geographic location; and
wherein the processor is configured to retrieve values of the one or more attributes associated with the map symbol from the database in response to the geographic location.

11. The computer system of claim 8 wherein the style property associated with the map symbol is selected from the group consisting of: font size, font, font color, line weight, line color, type of line, icon size, icon color, icon, animation type.

12. The computer system of claim 8 wherein the computational function is selected from the group consisting of: logical function, arithmetic function, mathematical function.

13. The computer system of claim 8
wherein the processor is configured to determine a value for a function upon values of the one or more attributes; and
wherein the processor is configured to determine the value for the style property associated with the map symbol in response to the value for the function.

14. The computer system of claim 8
wherein the processor is configured to retrieve updated values of one or more attributes associated with a map symbol;
wherein the processor is configured to perform the computational function upon the updated values of the one or more attributes to determine an updated value for the style property associated with a map symbol; and
wherein the processor is configured to provide an updated output representation of the map comprising the map symbol, in response to the updated value for the style property associated with the map symbol.

15. A computer program product for a computer system including a processor, resident on a computer-readable tangible media comprises:
code that directs a processor to retrieving values of one or more attributes associated with a map symbol;
code that directs a processor to perform a computational function upon the values of the one or more attributes to determine a value for a style property associated with the map symbol; and
code that directs a processor to output a representation of a map comprising the map symbol, in response to the value for the style property associated with the map symbol.

16. The computer program product of claim 15 further comprising code that directs a processor to display the map to a user.

17. The computer program product of claim 15 further comprising:
code that directs a processor to receive identification of a geographic location; and
code that directs a processor to determine the map symbol in response to the geographic location.

18. The computer program product of claim 15 wherein the style property of the map symbol is selected from the group consisting of: font size, font, font color, line weight, line color, type of line, icon size, icon color, icon, animation style.

19. The method of claim 15 further comprising
code that directs a processor to retrieving updated values of one or more attributes associated with the map symbol;
code that directs a processor to perform the computational function upon the updated values of the one or more attributes to determine an updated value for a style property associated with the map symbol; and
code that directs a processor to output a representation of a map comprising the map symbol, in response to the updated value for the style property associated with the map symbol.

20. The computer program product of claim 15
wherein the processor is configured to determine a value for a function upon values of the one or more attributes;
wherein the processor is configured to compare the value to a threshold;
wherein when the value exceeds the threshold, the processor is configured to determine use a first value for the value of the style property; and
wherein when the value does not exceed the threshold, the processor is configured to determine use a second value for the value of the style property.
